(19) United States
(12) Patent Application Publication
(10) Pub. No.: US 2026/0176422 A1
(43) Pub. Date: Jun. 25, 2026

(54) POLYMER AND COMPOSITION EMPLOYING THE SAME

(71) Applicant: INDUSTRIAL TECHNOLOGY RESEARCH INSTITUTE, Hsinchu (TW)

(72) Inventors: Jyh-Long JENG, New Taipei City (TW); Jeng-Yu TSAI, Chiayi City (TW)

(73) Assignee: INDUSTRIAL TECHNOLOGY RESEARCH INSTITUTE, Hsinchu (TW)

(21) Appl. No.: 19/000,877

(22) Filed: Dec. 24, 2024

(51) Int. Cl. C08G 73/10; C09D 4/06; C09D 179/08

(52) U.S. Cl. CPC C08G 73/1042; C08G 73/1007; C08G 73/1067; C08G 73/1071; C09D 4/06; C09D 179/08

(57) ABSTRACT

A polymer and a composition employing the same are provided. The polymer includes at least one first repeating unit of Formula (I) and at least one second repeating unit of Formula (II)

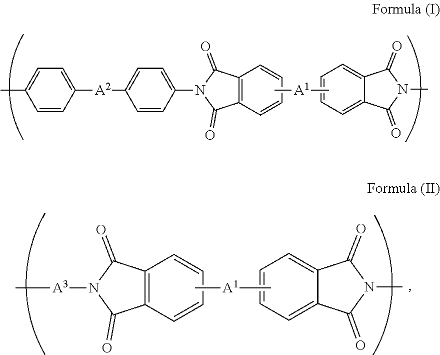

wherein A¹, A² and A³ are as defined in the specification. The composition includes 100 parts by weight of the polymer.

### TECHNICAL FIELD

The disclosure relates to a polymer and a composition employing the same.

### BACKGROUND

Polyimide exhibits excellent insulation properties, mechanical strength, chemical resistance, weather resistance, and thermal tolerance. It is widely used in various fields, including microelectronics and optics, as a high-performance polymer. However, conventional polyimides do not exhibit dielectric properties sufficient to maintain adequate insulation in high-frequency communications. Therefore, a large amount of dielectric powder is typically added to enhance their dielectric characteristics. However, when the amount of dielectric powder additive is too high, it may compromise the mechanical strength of the resulting film layer, thereby affecting the functionality and reliability of electronic products.

Accordingly, there is a need for new polyimide materials to solve the problems faced by conventional technologies.

### SUMMARY

The disclosure provides a polymer suitable for use in a composition that can be patterned by a photolithography process, for example. The polymer of the disclosure may have a first repeating unit and a second repeating unit, wherein the first repeating unit has a structure of Formula (I), and the second repeating unit has a structure of Formula (II)

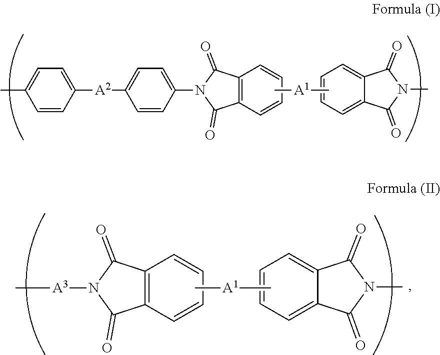

wherein A¹ is O,

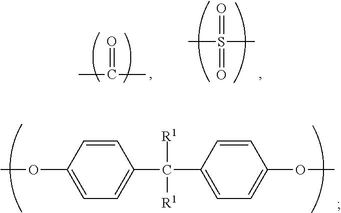

### A² is

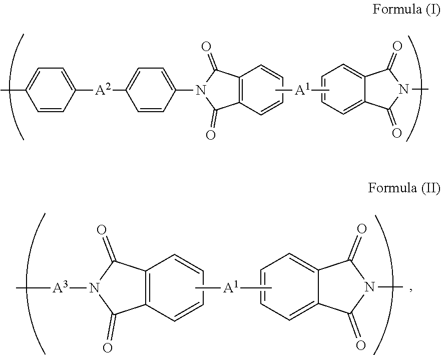

### A³ is

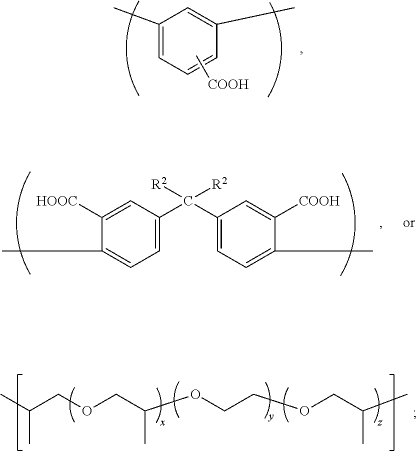

### A⁴ is

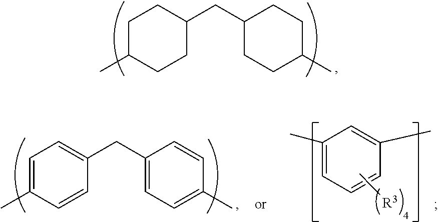

R¹, R² and R³ are independently H, F, C1-C4 alkyl group, or C1-C4 fluoroalkyl group; x and z are independently 0, or an integer from 1 to 15, and at least one of x and z is not 0; and y is independently an integer from 1 to 15.

According to embodiments of the disclosure, the disclosure also provides a composition that can be patterned by a photolithography process, for example. The composition of the disclosure includes 100 parts by weight of the polymer of the disclosure and 0.5 to 10 parts by weight of a photo-initiator.

A detailed description is given in the following embodiments.

### DETAILED DESCRIPTION

The polymer and a composition employing the same are described in detail in the following description. In the following detailed description, for purposes of explanation, numerous specific details and embodiments are set forth in order to provide a thorough understanding of the present disclosure. The specific elements and configurations described in the following detailed description are set forth in order to clearly describe the present disclosure. It will be apparent, however, that the exemplary embodiments set forth herein are used merely for the purpose of illustration, and the inventive concept may be embodied in various forms without being limited to those exemplary embodiments. In addition, the drawings of different embodiments may use like and/or corresponding numerals to denote like and/or corresponding elements in order to clearly describe the present disclosure. However, the use of like and/or corresponding numerals in the drawings of different embodiments does not suggest any correlation between different embodiments. As used herein, the term “about” in quantitative terms refers to plus or minus an amount that is general and reasonable to persons skilled in the art.

Furthermore, the use of ordinal terms such as “first”, “second”, “third”, etc., in the disclosure to modify an element does not by itself connote any priority, precedence, order of one claim element over another or the temporal order in which it is formed, but are used merely as labels to distinguish one claim element having a certain name from another element having the same name (but for use of the ordinal term) to distinguish the claim elements.

The embodiments of the disclosure provide a polymer. The polymer of the disclosure can enhance the dielectric characteristics of polyimide (with a dielectric constant (Dk) greater than or equal to 4.2) while maintaining high insulation performance, dimensional stability, mechanical strength, chemical resistance, weather resistance, and thermal tolerance.

According to embodiments of the disclosure, the polymer of the disclosure may further be combined with a photo-initiator to prepare a composition suitable for patterning via a photolithography process. Due to the addition of the polymer of the disclosure with excellent dielectric characteristics, the composition can form a patterned film layer with high dielectric properties and mechanical strength while maintaining a lower dielectric powder content. The layer formed from the composition can be applied in heterogeneous integrated chips, such as a high-Dk dielectric thin-film placed between electrode layers to form a parallel plate capacitor, serving as a decoupling capacitor to reduce parasitic inductance effects and suppress noise in high-speed edge computing. According to embodiments of the disclosure, in addition to the above applications, the composition can also be widely used in display devices, optoelectronic devices, and the preparation of wearable devices.

According to embodiments of the disclosure, the polymer of the disclosure may have a first repeating unit and a second repeating unit, wherein the first repeating unit has a structure of Formula (I) and the second repeating unit has a structure of

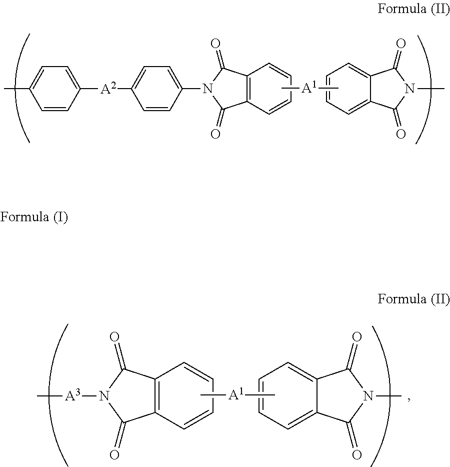

wherein A¹ is O,

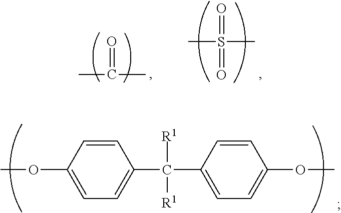

### A² is

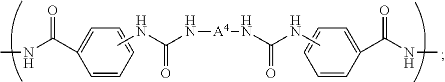

### A³ is

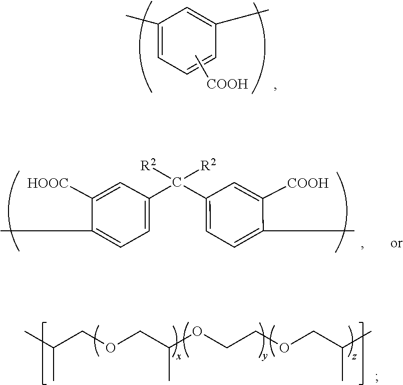

### A⁴ is

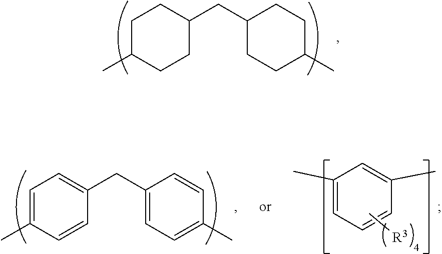

R¹, R² and R³ are independently H, F, C1-C4 alkyl group, or C1-C4 fluoroalkyl group; x and z are independently 0, or an integer from 1 to 15 (such as 1, 2, 3, 4, 5, 6, 7, 8, 9, 10, 11, 12, 13, 14, 15), and at least one of x and z is not 0; and y is independently an integer from 1 to 15 (such as 1, 2, 3, 4, 5, 6, 7, 8, 9, 10, 11, 12, 13, 14, 15).

According to embodiments of the disclosure, the C1-C4 alkyl group of the disclosure may be a linear or branched alkyl group. For example, the C1-C4 alkyl group of the disclosure may be methyl, ethyl, n-propyl, isopropyl, n-butyl, sec-butyl, iso-butyl, or tert-butyl. According to embodiments of the disclosure, the C1-C4 fluoroalkyl group of the disclosure may be an alkyl group which a part of or all hydrogen atoms bonded on the carbon atom are replaced with fluorine atoms, and C₁₋₄ fluoroalkyl group can be linear or branched, such as fluoromethyl, fluoroethyl, fluoropropyl, fluorobutyl, or an isomer thereof. Herein, fluoromethyl group may be monofluoromethyl group, difluoromethyl group or trifluoromethyl group, and fluoroethyl may be monofluoroethyl group, difluoroethyl group, trifluoroethyl group, tetrafluoroethyl, or perfluoroethyl. According to embodiments of the disclosure, the C1-C4 fluoroalkyl group of the disclosure may be fluoromethyl, fluoroethyl, n-fluoropropyl, isofluoropropyl, n-fluorobutyl, sec-fluorobutyl, iso-fluorobutyl, or tert-fluorobutyl.

According to embodiments of the disclosure, the first repeating unit and the second repeating unit may be arranged in a random or block fashion. According to embodiments of the disclosure, in the polymer, the molar ratio of the first repeating unit to the second repeating unit may be 1:10 to 1:2, such as 1:9, 1:8, 1:7, 1:6, 1:5, 1:4, or 1:3. When the molar number of the first repeating unit is relatively too low, the dielectric characteristics of the polymer cannot be effectively enhanced. Moreover, when the molar number of the first repeating unit is relatively too high, the composition prepared from the polymer is prone to solid precipitation due to poor compatibility, making it unable to form a colloidal solution for use in the coating process.

According to embodiments of the disclosure, the polymer of the disclosure may have at least one first repeating unit and at least one second repeating unit. For example, the polymer of the disclosure may have one kind of the first repeating unit, and two kinds of the second repeating unit, wherein the second repeating unit is

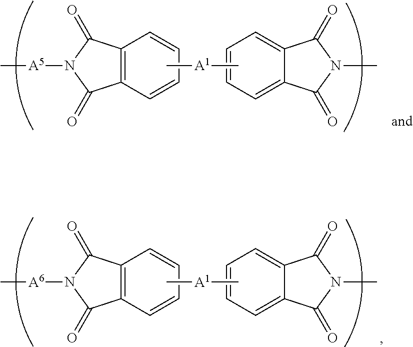

wherein A⁵ is

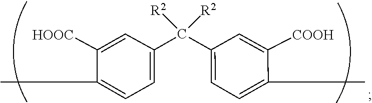

### A⁶ is

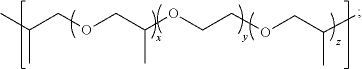

R² are independently H, F, C1-C4 alkyl group, or C1-C4 fluoroalkyl group; x and z are independently 0, or an integer from 1 to 15, and at least one of x and z is not 0; and y is independently an integer from 1 to 15.

According to embodiments of the disclosure, the polymer of the disclosure may be prepared by reacting a dianhydride of Formula (III) with a diamine of Formula (IV) and diamine of Formula (V) to undergo a copolymerization

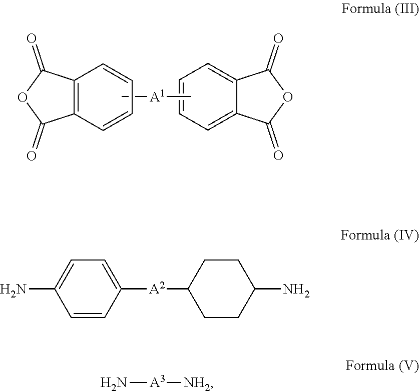

wherein A¹ is O,

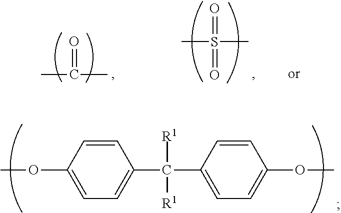

### A² is

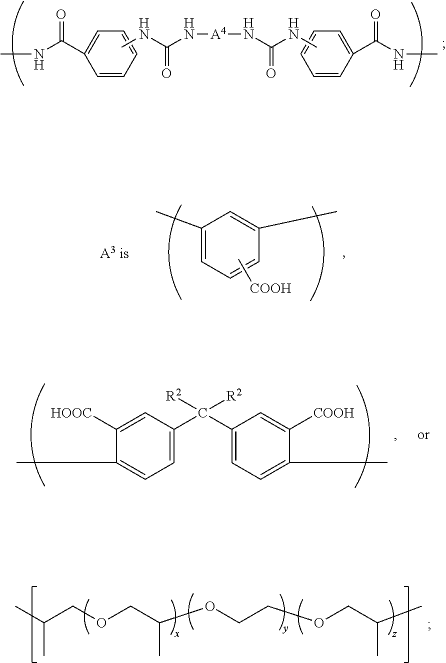

### A⁴ is

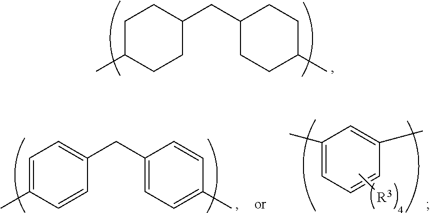

R¹, R² and R³ are independently H, F, C1-C4 alkyl group, or C1-C4 fluoroalkyl group; x and z are independently 0, or an integer from 1 to 15, and at least one of x and z is not 0; and y is independently an integer from 1 to 15. According to embodiments of the disclosure, the ratio of the molar number of the dianhydride of Formula (III) to the total molar number of the diamine of Formula (IV) and the diamine of Formula (V) may be about 100:115 to 100:90, such as about 100:110, 100:105, 100:100, or 100:95. According to embodiments of the disclosure, the molar ratio of the diamine of Formula (IV) to the diamine of Formula (V) may be 1:10 to 1:2, such as 1:9, 1:8, 1:7, 1:6, 1:5, 1:4, or 1:3.

According to embodiments of the disclosure, the dianhydride of Formula (III) may be 4,4′-oxydiphthalic anhydride (4,4′-ODPA), 3,3′,4,4′-benzophenonetetracarboxylic dianhydride (BTDA), 4,4′-(4,4′-isopropylidenediphenoxy)diphthalic anhydride (BPADA), or 3,3′,4,4′-diphenylsulfonetetracarboxylic dianhydride (DSDA).

According to embodiments of the disclosure, the diamine of Formula (IV) may be prepared by reacting 4,4′-diaminobenzanilide (DABA) with diisocyanate compound, wherein the molar ratio of 4,4′-diaminobenzanilide to diisocyanate compound may be about 1.5:1 to 2.2:1, (such as 2:1). According to embodiments of the disclosure, the diisocyanate compound of the disclosure may be 4,4′-methylene diphenyl diisocyanate (MDI), tolylene-2,4-diisocyanate (2,4-TDI), or 4,4′-methylene dicyclohexyl diisocyanate (H12MDI).

According to embodiments of the disclosure, the diamine of Formula (V) may be

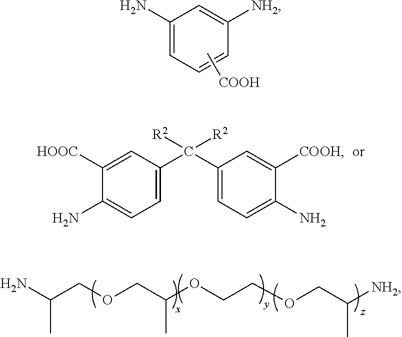

wherein R², x, y and z are the same as defined above.

According to embodiments of the disclosure, the weight average molecular weight of the polymer of the disclosure may be 5,000 g/mol to 30,000 g/mol, such as 6,000 g/mol, 8,000 g/mol, 10,000 g/mol, 20,000 g/mol, 50,000 g/mol, 80,000 g/mol, 100,000 g/mol, 200,000 g/mol, 300,000 g/mol, 400,000 g/mol, 500,000 g/mol, 700,000 g/mol, or 800,000 g/mol. According to embodiments of the disclosure, the weight average molecular weight (Mw) of the polymer of the disclosure can be determined by gel permeation chromatography (GPC) based on a polystyrene calibration curve. According to embodiments of the disclosure, the intrinsic viscosity of the polymer may be about 0.15 dL/g to 1.0 dL/g, such as 0.2 dL/g, 0.3 dL/g, 0.4 dL/g, 0.5 dL/g, 0.6 dL/g, 0.7 dL/g, 0.8 dL/g, or 0.9 dL/g. The polymer of the disclosure can be prepared into a solution with a concentration of 0.3 g/dL using a co-solvent (phenol and tetrachloroethane in a volume ratio of 6:4). The relative viscosity of the solution is measured by an Ostwald viscometer, and the intrinsic viscosity (IV) is then calculated.

According to embodiments of the disclosure, the disclosure provides a composition, such as a composition capable of forming high-resolution patterns using a photolithography process. According to embodiments of the disclosure, the composition includes 100 parts by weight of the aforementioned polymer and 3 to 10 parts by weight of a photo-initiator (such as 4 parts by weight, 5 parts by weight, 6 parts by weight, 7 parts by weight, 8 parts by weight, or 9 parts by weight).

According to embodiments of the disclosure, the photo-initiator may be a benzoin-based compound, an acetophenone-based compound, a thioxanthone-based compound, a ketal compound, a benzophenone-based compound, an α-aminoacetophenone compound, an acylphosphine oxide compound, a biimidazole-based compound, a triazine-based compound, or a combination thereof.

According to embodiments of the disclosure, the acetophenone-based compound may be a photo-initiator manufactured by Ciba Geigy with the trade number Irgacure 2959, Irgacure 184, Irgacure 500, Irgacure 651, Irgacure 369, Irgacure 379, Irgacure 907, or Darocur 1173. According to embodiments of the disclosure, the acylphosphine oxide compound may be a photo-initiator manufactured by Ciba Geigy with the trade number Irgacure 819 or Irgacure 1800, and a photo-initiator manufactured by BASF with the trade number Lucirin TPO or Lucirin TPO-L. According to embodiments of the disclosure, the initiator of the disclosure may also be a photo-initiator manufactured by LAMBSON with the trade number Esacure 1001M, Esacure KIP150, Speedcure BEM, Speedcure EHA, Speedcure BMS, Speedcure MBP, Speedcure PBZ, Speedcure ITX, Speedcure DETX, Speedcure EBD, Speedcure MBB, or Speedcure BP, or a photo-initiator manufactured by Ciba Geigy with the trade number Irgacure 2100, Irgacure 250, or Irgacure 784.

According to embodiments of the disclosure, the primary absorption wavelength of the photo-initiator of the disclosure may range from about 300 nm to 410 nm. According to embodiments of the disclosure, the primary absorption wavelength of the photo-initiator may also be less than about 300 nm to meet the UV exposure requirements of commercially available I-line and H-line systems.

According to embodiments of the disclosure, the composition of the disclosure may further include 10 to 30 parts by weight of an acrylate monomer (such as 12 parts by weight, 14 parts by weight, 16 parts by weight, 18 parts by weight, 20 parts by weight, 22 parts by weight, 24 parts by weight, or 26 parts by weight). When the amount of acrylate monomer is too low, the composition formed from the polymer of the disclosure and the acrylate monomer will be difficult to degrade after curing. When the amount of acrylate monomer is too high, the composition will have low compatibility and would not mix uniformly.

According to embodiments of the disclosure, the acrylate monomer may be a compound having an acrylate group, a compound having a methacrylate group, or a combination thereof, for example, the acrylate monomer may be a multi-acrylate compound, a multi-methacrylate compound, or a combination thereof.

According to embodiments of the disclosure, the acrylate monomer may be 1,6-hexanediol diacrylate (HDDA), 1,6-hexanediol dimethacrylate, 1,9-bis(acryloyloxy)nonane, 1,9-bis(methacryloyloxy)nonane, 1,10-decanediol diacrylate (DDDA), 1,10-decanediol dimethacrylate, neopentyl glycol diacrylate, neopentyl glycol dimethacrylate, polyethylene glycol(200)diacrylate (PEG200DA), polyethylene glycol(400)diacrylate (PEG400DA), polyethylene glycol(600)diacrylate (PEG600DA), dipropylene glycol diacrylate (DPGDA), dipropylene glycol dimethacrylate (DPGDA), tripropylene glycol diacrylate (TPGDA), tripropylene glycol dimethacrylate, di(ethylene glycol)diacrylate, di(ethylene glycol)dimethacrylate, triethylene glycol diacrylate (TIEGDA), triethylene glycol dimethacrylate, tetraethylene glycol diacrylate (TTEGDA), tetraethylene glycol dimethacrylate, dipentaerythritol hexaacrylate (DPHA), dipentaerythritol hexamethacrylate, dipentaerythritol pentaacrylate (DPPA), dipentaerythritol pentamethacrylate, polypropylene glycol diacrylate, poly(tetramethylene ether glycol)diacrylate, poly(ethylene-polypropylene glycol)diacrylate, tricyclodecanedimethanol diacrylate (TCDDMDA), trimethylolpropane triacrylate (TMPTA), pentaerythritol triacrylate (PETIA), pentaerythritol tetraacrylate (PETTA), di(trimethylolpropane)tetraacrylate (Di-TMPTTA), di(polypentaerythritol)polyacrylate, polypentaerythritol polyacrylate, polybutadiene diacrylate (PBDDA), 3-methyl 1,5-pentanediol diacrylate (MPDA), ethoxylated 3 bisphenol A diacrylate (BPA3EODA), tris(2-hydroxyethyl)isocyanurate triacrylate (THEICTA), ethoxylated(20)trimethylolpropane triacrylate (TMP20EOTA), ethoxylated 3 trimethylolpropane triacrylate (TMP3EOTA), propoxylated 3 trimethylolpropane triacrylate (TMP3POTA), ethoxylated pentaerythritol tetraacrylate, ethoxylated 6 trimethylolpropane triacrylate (TMP6EOTA), ethoxylated 9 trimethylolpropane triacrylate (TMP9EOTA), ethoxylated 4 bisphenol A diacrylate (BPA4EODA), ethoxylated 10 bisphenol A diacrylate (BPA10EODA), esterdiol diacrylate (EDDA), alkoxylated diacrylate, propoxylated 2 neopentyl glycol diacrylate (PONPGDA), propoxylated 3 glyceryl triacrylate (GPTA), ethoxylated 15 trimethylolpropane triacrylate (TMP15EOTA), ethoxylated 12 glyceryl triacrylate (G12EOTA), or a combination thereof.

According to embodiments of the disclosure, the composition of the disclosure may further include 0.1 to 20 parts by weight (such as 0.5 parts by weight, 1 part by weight, 2 parts by weight, 5 parts by weight, 10 parts by weight, or 15 parts by weight) of a crosslinking agent. According to embodiments of the disclosure, the crosslinking agent may be an oxazoline crosslinking agent. According to embodiments of the disclosure, the oxazoline crosslinking agent may be 2-vinyl-2-oxazoline, 2-vinyl-4-methyl-2-oxazoline, 2-vinyl-5-methyl-2-oxazoline, 2-isopropenyl-2-oxazoline, 2-isopropenyl-4-methyl-2-oxazoline, 2-isopropenyl-5-ethyl-2-oxazoline, 2,2′-bis-(2-oxazoline), 2,2′-methylene-bis-(2-oxazoline), 2,2′-ethylene-bis-(2-oxazoline), 2,2′-trimethylene-bis-(2-oxazoline), 2,2′-tetramethylene-bis-(2-oxazoline), 2,2′-hexamethylene-bis-(2-oxazoline), 2,2′-octamethylene-bis-(2-oxazoline), 2,2′-ethylene-bis-(4,4′-dimethyl-2-oxazoline), 2,2′-p-phenylenebis-(2-oxazoline), 2,2′-m-phenylenebis-(2-oxazoline), 2,2′-m-phenylenebis-(4,4′-dimethyl-2-oxazoline), bis-(2-oxazolinylcyclohexane) sulfide, bis-(2-oxazolinyl-norbornane) sulfide, or a combination thereof.

According to embodiments of the disclosure, the oxazoline crosslinking agent may be a commercially available product, such as Epocros™ K2010E, K2020E, K2030E, WS500, or WS700 (manufactured by Nippon Catalyst Chemical Industry Co., Ltd.).

According to embodiments of the disclosure, the composition of the disclosure may further include 60 to 85 parts by weight (such as 65 parts by weight, 70 parts by weight, 75 parts by weight, or 80 parts by weight) of a filler. According to embodiments of the disclosure, the filler may be an inorganic filler with higher dielectric coefficient. According to embodiments of the disclosure, the filler may be zinc oxide, zirconium oxide, aluminum oxide, silicon oxide, barium oxide, titanium dioxide, silicon carbide, boron nitride, aluminum nitride, magnesium carbonate, calcium carbonate, calcium phosphate, barium sulfate, barium titanate, calcium titanate, barium strontium titanate, lead zirconate titanate, or a combination thereof, or a combination thereof.

According to embodiments of the disclosure, the composition of the disclosure may further include a solvent, forcing all components of the composition being dissolved or uniformly dispersed in the solvent. For example, the solvent may be N-methyl-2-pyrrolidone, dimethylacetamide, gamma-butyrolactone, p-xylene, or a combination thereof, and the composition may have a solid content of 5 wt % to 45 wt % (such as about 6 wt %, 8 wt %, 10 wt %, 12 wt %, 14 wt %, 15 wt %, 18 wt %, 20 wt %, 21 wt %, 22 wt %, 25 wt %, 27 wt %, 29 wt %, 30 wt %, 32 wt %, 34 wt %, 35 wt %, 38 wt %, 40 wt %, 42 wt %, or 44 wt %). According to embodiments of the disclosure, the thickness of the film prepared from the composition is directly proportional to the solid content of the composition. Namely, the thickness of the film prepared from the film composition can be adjusted by varying the solid content of the film composition.

According to embodiments of the disclosure, the composition of the disclosure may include the polymer of the disclosure, a photoinitiator, and a solvent. In other embodiments, the film composition of the disclosure may include the polymer of the disclosure, a photoinitiator, an acrylate monomer, and a solvent. Alternatively, the film composition may include the polymer of the disclosure, a photoinitiator, an acrylate monomer, a crosslinking agent, and a solvent. Further, the film composition may include the polymer of the disclosure, a photoinitiator, an acrylate monomer, a crosslinking agent, a filler, and a solvent.

According to embodiments of the disclosure, the composition may substantially consist of the polymer of the disclosure, a photoinitiator, an acrylate monomer, a crosslinking agent, a filler, and a solvent. Namely, these components may be the main components of the composition. In addition, components other than these main components are defined as minor components. According to embodiments of the disclosure, minor components may include catalysts used for polymer preparation, unreacted diamines or dianhydrides used in polymer preparation, additives, or combinations thereof. The content of minor components may range from 0.1 wt % to 10 wt %, based on the total weight of the composition. According to embodiments of the disclosure, the additive may be any additive known to those skilled in the art, such as a leveling agent, colorant, dye, defoamer, flame retardant, viscosity modifier, thixotropic agent, dispersant, stabilizer, or a combination thereof. In other embodiments, the film composition of the disclosure may consist of the aforementioned main components and minor components.

According to embodiments of the disclosure, the disclosure also provides a film layer prepared from the composition of the disclosure. The method for preparing the film layer may include forming a coating of the composition on a substrate through a coating process. Next, the coating undergoes an exposure process and optionally a baking process to obtain the film layer. According to embodiments of the disclosure, the coating process may include screen printing, spin coating, bar coating, blade coating, roller coating, dip coating, spray coating, or brush coating. The light source for the exposure process may be ultraviolet (UV) light with a wavelength ranging from 150 nm to 400 nm, and the exposure dose may range from 50 mJ/cm² to 1,000 mJ/cm² (such as 70 mJ/cm², 100 mJ/cm², 200 mJ/cm², 300 mJ/cm², 500 mJ/cm², 600 mJ/cm², or 800 mJ/cm²). The baking process temperature may range from approximately 100° C. to 300° C., such as 100° C. to 250° C. According to embodiments of the disclosure, the baking process may be a multi-stage baking process.

Below, exemplary embodiments will be described in detail so as to be easily realized by a person having ordinary knowledge in the art. The inventive concept may be embodied in various forms without being limited to the exemplary embodiments set forth herein.

Table 1 lists the reagents involved in the Examples of the disclosure.

TABLE 1

| abbreviation | name | structure |
|---|---|---|
| MDI | 4,4′-methylene diphenyl diisocyanate | 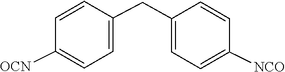 |
| DABA | 4,4′-diaminobenzanilide | 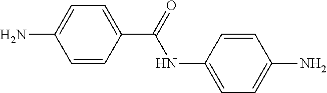 [SMILES: Nc1ccc(NC(=O)c2ccc(N)cc2)cc1] |
| DABZ | 3,5-diaminobenzoic acid | 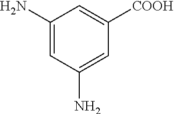 [SMILES: Nc1cc(N)cc(C(=O)O)c1] |
| MBAA | 6,6′-diamino-3,3′-methylenedibenzoic acid | 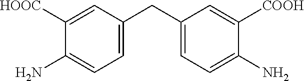 [SMILES: Nc1ccc(Cc2ccc(N)c(C(=O)O)c2)cc1C(=O)O] |
| 2,4-TDI | tolylene-2,4-diisocyanate | 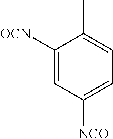 |
| H12MDI | 4,4′-methylene dicyclohexyl diisocyanate | 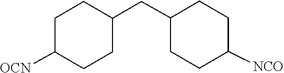 |
| 4,4′-ODPA | 4,4′-oxydiphthalic anhydride | 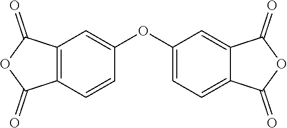 [SMILES: O=C1OC(=O)c2cc(Oc3ccc4c(c3)C(=O)OC4=O)ccc21] |
| BTDA | 3,3′,4,4′-benzophenonetetracarboxylic dianhydride | 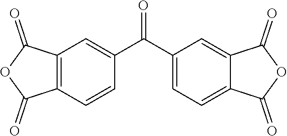 [SMILES: O=C(c1ccc2c(c1)C(=O)OC2=O)c1ccc2c(c1)C(=O)OC2=O] |
| BPADA | 4,4′-(4,4′- isopropylidenediphenoxy)diphthalic anhydride | 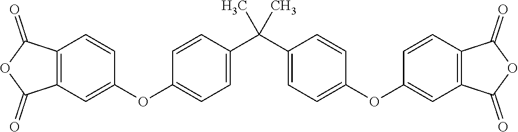 [SMILES: CC(C)(c1ccc(Oc2ccc3c(c2)C(=O)OC3=O)cc1)c1ccc(Oc2ccc3c(c2)C(=O)OC3=O)cc1] |

### Preparation of Polyimide Solution

### Example 1

4,4′-methylene diphenyl diisocyanate (MDI) (0.05 mol), 4,4′-diaminobenzanilide (DABA) (0.1 mol), and N-methyl-2-pyrrolidone (NMP) (513 g) were mixed under nitrogen atmosphere. The resulting solution was stirred at 140° C. for 4 hours and then cooled to room temperature. Next, polyether diamine (Jeffamine® ED-900) (0.05 mol), 6,6′-diamino-3,3′-methylenedibenzoic acid (MBAA) (0.1 mol), and 4,4′-oxydiphthalic anhydride (4,4′-ODPA) (0.2 mol) were added. After stirring the mixture at room temperature for 2 hours, the result was heated to 180° C. and stirred for 4 hours, obtaining Polyimide solution (1) (a clear, viscous solution). In particular, the obtained polyimide has a repeating unit (1) (having a structure of

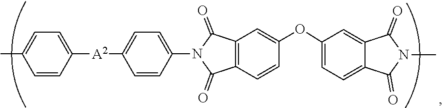

### A² is

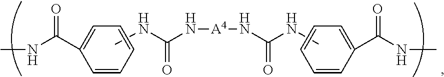

### A⁴ is

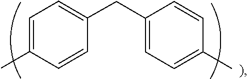

repeating unit (2) (having a structure of

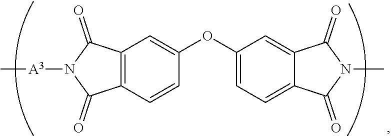

### A³ is

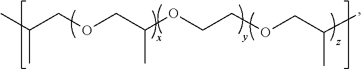

the average value of y is 12.5, and the average value of x+z is approximately 6), and repeating unit (3) (having a structure of

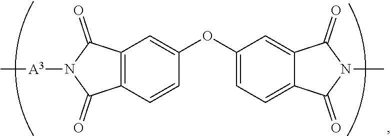

### A³ is

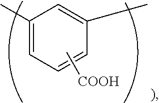

and the molar ratio of the repeating unit (1) to the repeating unit (2) and the repeating unit (3) is about 33:100.

### Example 2

4,4′-methylene diphenyl diisocyanate (MDI) (0.06 mol), 4,4′-diaminobenzanilide (DABA) (0.12 mol), and N-methyl-2-pyrrolidone (NMP) (400 g) were mixed under nitrogen atmosphere. The resulting solution was stirred at 140° C. for 4 hours and then cooled to room temperature. Next, 6,6′-diamino-3,3′-methylenedibenzoic acid (MBAA) (0.14 mol) and 4,4′-oxydiphthalic anhydride (4,4′-ODPA) (0.2 mol) were added. After stirring the mixture at room temperature for 2 hours, the result was heated to 180° C. and stirred for 4 hours, obtaining Polyimide solution (2) (a clear, viscous solution). In particular, the obtained polyimide has a repeating unit (1) (having a structure of

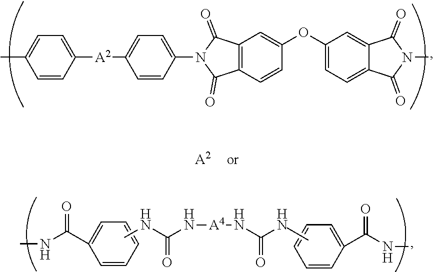

### A⁴ is

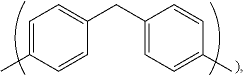

and repeating unit (2) (having a structure of

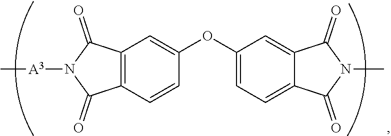

### A³ is

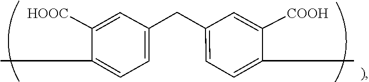

and the molar ratio of the repeating unit (1) to the repeating unit (2) is about 43:100.

### Example 3

4,4′-methylene diphenyl diisocyanate (MDI) (0.01 mol), 4,4′-diaminobenzanilide (DABA) (0.02 mol), and N-methyl-2-pyrrolidone (NMP) (293 g) were mixed under nitrogen atmosphere. The resulting solution was stirred at 140° C. for 4 hours and then cooled to room temperature. Next, 6,6′-diamino-3,3′-methylenedibenzoic acid (MBAA) (0.09 mol) and 3,3′,4,4′-benzophenonetetracarboxylic dianhydride (BTDA) (0.1 mol) were added. After stirring the mixture at room temperature for 2 hours, the result was heated to 180° C. and stirred for 4 hours, obtaining Polyimide solution (3) (a clear, viscous solution). In particular, the obtained polyimide has a repeating unit (1) (having a structure of

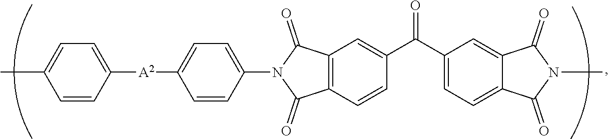

### A² is

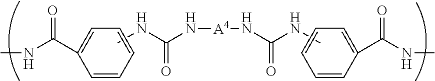

### A⁴;

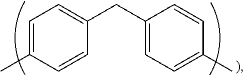

and repeating unit (2) (having a structure of

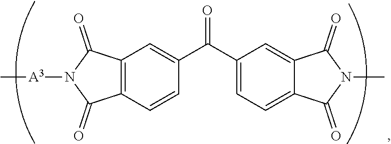

### A³ is

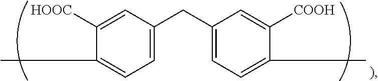

and the molar ratio of the repeating unit (1) to the repeating unit (2) is about 11:100.

### Example 4

Tolylene-2,4-diisocyanate (2,4-TDI) (0.04 mol), 4,4′-diaminobenzanilide (DABA) (0.08 mol), and N-methyl-2-pyrrolidone (NMP) (400 g) were mixed under nitrogen atmosphere. The resulting solution was stirred at 140° C. for 4 hours and then cooled to room temperature. Next, 6,6′-diamino-3,3′-methylenedibenzoic acid (MBAA) (0.16 mol) and 4,4′-oxydiphthalic anhydride (4,4′-ODPA) (0.2 mol) were added. After stirring the mixture at room temperature for 2 hours, the result was heated to 180° C. and stirred for 4 hours, obtaining Polyimide solution (4) (a clear, viscous solution). In particular, the obtained polyimide has a repeating unit (1) (having a structure of

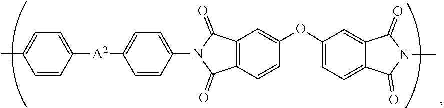

### A² is

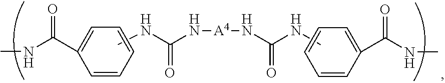

### A⁴ is

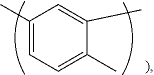

and repeating unit (2) (having a structure of

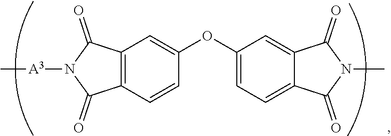

### A³ is

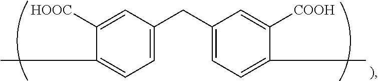

and the molar ratio of the repeating unit (1) to the repeating unit (2) is about 25:100.

### Example 5

4,4′-methylene dicyclohexyl diisocyanate (H12MDI) (0.02 mol), 4,4′-diaminobenzanilide (DABA) (0.04 mol), and N-methyl-2-pyrrolidone (NMP) (440 g) were mixed under nitrogen atmosphere. The resulting solution was stirred at 140° C. for 4 hours and then cooled to room temperature. Next, 3,5-diaminobenzoic acid (DABZ) (0.16 mol) and 4,4′-(4,4′-isopropylidenediphenoxy)diphthalic anhydride (BPADA) (0.2 mol) were added. After stirring the mixture at room temperature for 2 hours, the result was heated to 180° C. and stirred for 4 hours, obtaining Polyimide solution (5) (a clear, viscous solution). In particular, the obtained polyimide has a repeating unit (1) (having a structure of

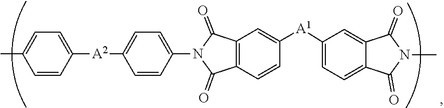

### A¹ is

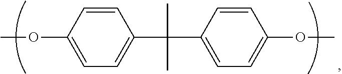

### A² is

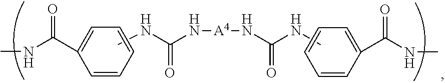

### A⁴ is

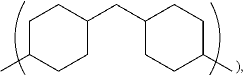

and repeating unit (2) (having a structure of

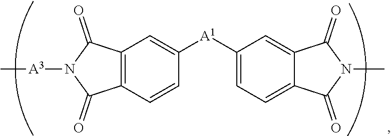

### A¹ is

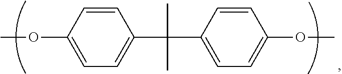

### A³ is

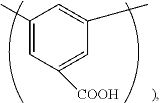

and the molar ratio of the repeating unit (1) to the repeating unit (2) is about 11:100.

### Comparative Example 1

4,4′-methylene diphenyl diisocyanate (MDI) (0.035 mol), 4,4′-diaminobenzanilide (DABA) (0.07 mol), and N-methyl-2-pyrrolidone (NMP) (226 g) were mixed under nitrogen atmosphere. The resulting solution was stirred at 140° C. for 4 hours and then cooled to room temperature. Next, 6,6′-diamino-3,3′-methylenedibenzoic acid (MBAA) (0.065 mol) and 3,3′,4,4′-benzophenonetetracarboxylic dianhydride (BTDA) (0.1 mol) were added. After stirring the mixture at room temperature for 2 hours, the result was heated to 180° C. and stirred for 4 hours, obtaining Polyimide solution (6) (solid precipitation). In particular, the obtained polyimide has a repeating unit (1) (having a structure of

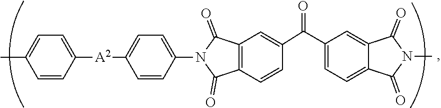

### A² is

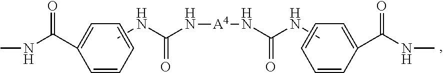

### A⁴ is

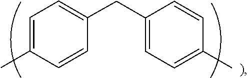

and repeating unit (2) (having a structure of

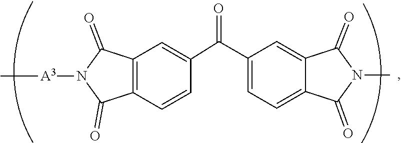

### A³ is

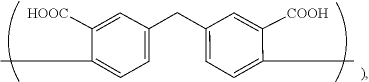

and the molar ratio of the repeating unit (1) to the repeating unit (2) is about 54:100.

### Comparative Example 2

4,4′-methylene diphenyl diisocyanate (MDI) (0.005 mol), 4,4′-diaminobenzanilide (DABA) (0.01 mol), and N-methyl-2-pyrrolidone (NMP) (430 g) were mixed under nitrogen atmosphere. The resulting solution was stirred at 140° C. for 4 hours and then cooled to room temperature. Next, 6,6′-diamino-3,3′-methylenedibenzoic acid (MBAA) (0.095 mol) and 3,3′,4,4′-benzophenonetetracarboxylic dianhydride (BTDA) (0.1 mol) were added. After stirring the mixture at room temperature for 2 hours, the result was heated to 180° C. and stirred for 4 hours, obtaining Polyimide solution (7) (a clear, viscous solution). In particular, the obtained polyimide has a repeating unit (1) (having a structure of

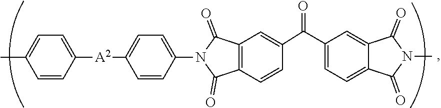

### A² is

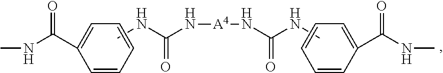

### A⁴ is

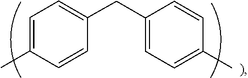

and repeating unit (2) (having a structure of

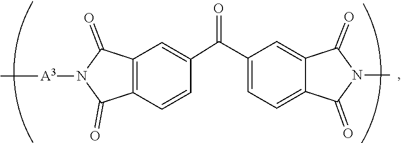

### A³ is

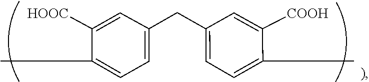

and the molar ratio of the repeating unit (1) to the repeating unit (2) is about 54:100.

### Comparative Example 3

3,5-diaminobenzoic acid (DABZ) (0.08 mol), 1,3-Bis(3-aminopropyl)tetramethyldisiloxane (Si248) (0.005 mol), 3-aminophenol (0.03 mol), N-methyl-2-pyrrolidone (NMP) (150 g), and 4,4′-oxydiphthalic anhydride (4,4′-ODPA) (0.1 mol) were mixed under a nitrogen atmosphere. After stirring the resulting solution at room temperature for 4 hours, the mixture was heated to 180° C. and stirred for 4 hours to obtain Polyimide solution (8) (a clear, viscous solution).

### Preparation of Composition

Polyimide solutions (1)-(5), (7) and (8) (20 g) prepared from Examples 1-5 and Comparative Examples 2 and 3 were individually mixed evenly with a photoinitiator (manufactured by BASF with a trade name Irgacure OXE01) (0.25 g), tris(2-hydroxyethyl)isocyanurate triacrylate (THEICTA) (1.5 g), and 2,2′-bis-(2-oxazoline) (0.5 g) to obtain Compositions (1)-(7). Next, the dielectric properties, resolution, and chemical resistance of the films formed by Compositions (1)-(7) were evaluated, and the results are shown in Table 2.

The dielectric property was evaluated as follows. The composition was coated onto a glass substrate to form a coating, and then the coating was baked at 100° C. for 10 minutes. Next, the coating (with a thickness of about 10 μm) was subjected to an exposure process (with an energy of 600 mJ/cm²) and then baked at 200° C. for 60 minutes to obtain a cured film. Next, the dielectric coefficient (Dk) of the cured film was measured at a frequency of 1 GHz by a microwave dielectrometer (available from AET Corporation).

The resolution was evaluated as follows. The composition was coated onto a wafer to form a coating, and then the coating was baked at 100° C. for 10 minutes. Next, the coating (with a thickness of about 8 μm) was subjected to an exposure process (with an energy of 500 mJ/cm² and a pattern having a line width of 15 μm and a line spacing of 15 μm), and then the coating was developed with cyclopentanone-caprolactam (CPL) for about 60-90 seconds. Next, the result was baked at 200° C. for 60 minutes to obtain a patterned film. The patterned film was observed. When the dry film after exposure and development achieves a pattern with a line width and line spacing of 15 μm, it was marked as “O”; otherwise, it was marked as “X.”

The chemical resistance was evaluated as follows. The composition was coated onto a wafer to form a coating, and then the coating was baked at 100° C. for 10 minutes. Next, the coating (with a thickness of about 10 μm) was subjected to an exposure process (with an energy of 600 mJ/cm²) and then baked at 200° C. for 60 minutes to obtain a cured film. Next, the cured film was immersed in TOK-106 (commercial product from Tokyo Ohka Kogyo) at 70° C. for 120 seconds, and then the cured film was rinsed with water for 5 minutes. The thickness and shape of the cured film was observed after treatment. If there was no significant change, it was marked as “O”; if there was a noticeable change, it was marked as “X.”

TABLE 2

| | first | | | |
|---|---|---|---|---|
| | repeating | | | |
| | unit:second | | | |
| | repeating | | | |
| | unit (molar | | resolution | chemical |
| | ratio of | dielectric | (15 μm/ | resistance |
| | diamine) | coefficient | 15 μm) | evaluation |
| Composition | 33:100 | 4.8 | ◯ | ◯ |
| (1) | | | | |
| Composition | 43:100 | 5.2 | ◯ | ◯ |
| (2) | | | | |
| Composition | 11:100 | 4.2 | ◯ | ◯ |
| (3) | | | | |
| Composition | 25:100 | 4.4 | ◯ | ◯ |
| (4) | | | | |
| Composition | 11:100 | 4.3 | ◯ | ◯ |
| (5) | | | | |
| Composition | 54:100 | 3.8 | ◯ | ◯ |
| (6) | | | | |
| Composition | 0:100 | 3.5 | ◯ | ◯ |
| (7) | | | | |

As shown in Table 2, when the composition includes the polymer of the disclosure and the molar ratio of the first repeating unit to the second repeating unit is between 10:100 and 50:100, the cured film layer obtained from the composition (i.e., Compositions (1)-(5) described in Examples 1-5) maintains good resolution and chemical resistance while exhibiting a higher dielectric coefficient (greater than 4.0).

Compositions (1)-(6) were each mixed with barium titanate (manufactured by Sakai Chemical Industry Co., Ltd. with the trade name of BT-02) to obtain Compositions (8)-(13), wherein the barium titanate content was 75 wt % based on the total solid content of the composition. Composition (7) was mixed with barium titanate (manufactured by Sakai Chemical Industry Co., Ltd. with the trade name of BT-02) to obtain Composition (14), wherein the barium titanate content was 87 wt % based on the total solid content of the composition.

Next, the dielectric properties, resolution, and flexibility of the films formed from Compositions (8)-(14) were evaluated, and the results are shown in Table 3.

The dielectric property was evaluated as described above. The resolution was evaluated as follows. The composition was coated onto a wafer to form a coating and baked at 100° C. for 10 minutes. Next, the coating (thickness of about 8 μm) was subjected to an exposure process (with an energy of 500 mJ/cm² and a pattern having a line width of 20 μm and a line spacing of 20 μm), and then the coating was developed with cyclopentanone-caprolactam (CPL) for about 60-90 seconds. Next, the result was baked at 200° C. for 60 minutes to obtain a patterned film. The patterned film was observed. When the dry film after exposure and development achieves a pattern with a line width and line spacing of 20 μm, it was marked as “O”; otherwise, it was marked as “X”.

The flexibility was evaluated as follows. The composition was coated onto a glass substrate to form a coating and baked at 100° C. for 10 minutes. Next, the coating (thickness of about 10 μm) was subjected to an exposure process (with an energy of 600 mJ/cm² and then the coating was baked at 200° C. for 60 minutes to obtain a cured film. The cured film was subjected to a bending test (bending angle of 180°). If the cured film did not crack or break, it was marked as “O”; otherwise, it was marked as “X”.

TABLE 3

| | first | | | |
|---|---|---|---|---|
| | repeating | | | |
| | unit:second | | | |
| | repeating | | resolution | |
| | unit (molar | dielectric | (20 μm/ | flexibility |
| | ratio) | coefficient | 20 μm) | evaluation |
| Composition | 33:100 | 51 | ◯ | ◯ |
| (8) | | | | |
| Composition | 43:100 | 58 | ◯ | ◯ |
| (9) | | | | |
| Composition | 11:100 | 42 | ◯ | ◯ |
| (10) | | | | |
| Composition | 25:100 | 46 | ◯ | ◯ |
| (11) | | | | |
| Composition | 11:100 | 45 | ◯ | ◯ |
| (12) | | | | |
| Composition | 54:100 | 35 | ◯ | ◯ |
| (13) | | | | |
| Composition | 0:100 | 42 | ◯ | X |
| (14) | | | | |

As shown in Table 3, when the composition includes the polymer of the disclosure and the molar ratio of the first repeating unit to the second repeating unit is between 10:100 and 50:100, the cured film layer obtained from the composition (i.e., Compositions (8)-(12) described in Examples 1-5) maintains good mechanical strength even with the addition of a large amount of dielectric powder (i.e., barium titanate), and the dielectric coefficient of the resulting film layer can reach above 40. In contrast, for Composition (14), the dielectric powder additive amount needs to be increased to 87 wt % for the film layer to achieve a dielectric coefficient above 40. However, the mechanical strength of the resulting film layer significantly deteriorates (failing the flexibility test).

Accordingly, due to the introduction of a prepolymer including an amide group and an ureido group (prepared from a specific ratio of specific diamines and specific diisocyanates), it is indeed possible to significantly enhance the dielectric properties of the resulting polyimide (achieving a dielectric coefficient (Dk) of 4.2 or greater) while maintaining high insulation performance, dimensional stability, mechanical strength, chemical resistance, weather resistance, and thermal tolerance.

It will be clear that various modifications and variations can be made to the disclosed methods and materials. It is intended that the specification and examples be considered as exemplary only, with the true scope of the disclosure being indicated by the following claims and their equivalents.

What is claimed is:

1. A polymer, which has a first repeating unit and a second repeating unit, wherein the first repeating unit has a structure of Formula (I), the second repeating unit has a structure of Formula (II) 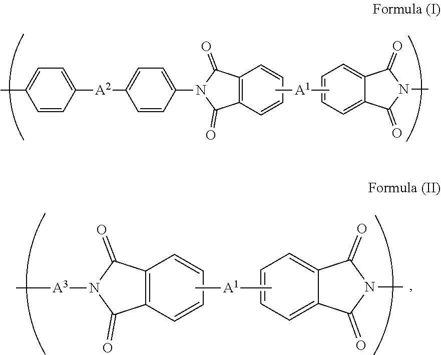
wherein A¹ is 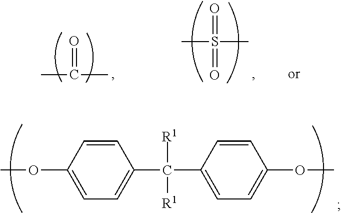
A² is 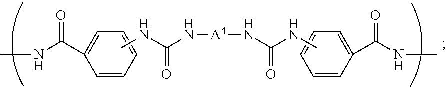
A³ is 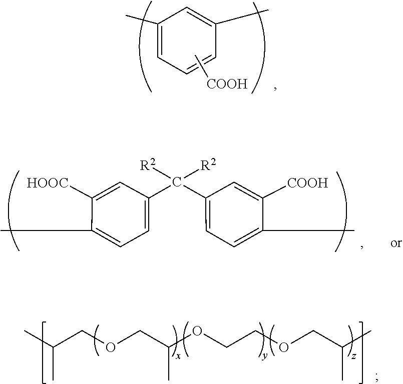
A⁴ is 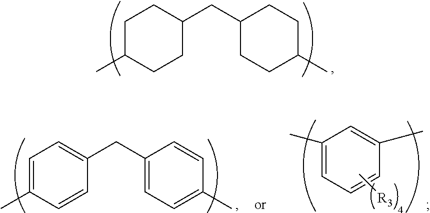
R¹, R² and R³ are independently H, F, C1-C4 alkyl group, or C1-C4 fluoroalkyl group; x and z are independently 0, or an integer from 1 to 15, and at least one of x and z is not 0; and y is independently an integer from 1 to 15.

2. The polymer as claimed in claim 1, wherein the first repeating unit and the second repeating unit are arranged in a random or block fashion.

3. The polymer as claimed in claim 1, wherein a molar ratio of the first repeating unit to the second repeating unit is 1:10 to 1:2.

4. A composition, comprising:
100 parts by weight of the polymer as claimed in claim 1; and
0.5 to 10 parts by weight of a photo-initiator.

5. The composition as claimed in claim 4, further comprising:
10 to 30 parts by weight of an acrylate monomer.

6. The composition as claimed in claim 5, wherein the acrylate monomer is a compound having an acrylate group, a compound having a methacrylate group, or a combination thereof.

7. The composition as claimed in claim 4, further comprising:
0.1 to 20 parts by weight of a crosslinking agent.

8. The composition as claimed in claim 7, wherein the crosslinking agent is an oxazoline crosslinking agent.

9. The composition as claimed in claim 4, further comprising:
60 to 85 parts by weight of a filler.

10. The composition as claimed in claim 9, wherein the filler is zinc oxide, zirconium oxide, aluminum oxide, silicon oxide, barium oxide, titanium dioxide, silicon carbide, boron nitride, aluminum nitride, magnesium carbonate, calcium carbonate, calcium phosphate, barium sulfate, barium titanate, calcium titanate, barium strontium titanate, lead zirconate titanate, or a combination thereof.
